(19) United States
(12) Patent Application Publication
(10) Pub. No.: US 2023/0324912 A1
(43) Pub. Date: Oct. 12, 2023

(54) UNMANNED VEHICLE CONTROL SYSTEM, UNMANNED VEHICLE, AND UNMANNED VEHICLE CONTROL METHOD

(71) Applicant: Komatsu Ltd., Tokyo (JP)

(72) Inventor: Yosuke Kadono, Tokyo (JP)

(73) Assignee: Komatsu Ltd., Tokyo (JP)

(21) Appl. No.: 18/025,210

(22) PCT Filed: Oct. 13, 2021
(86) PCT No.: PCT/JP2021/037925

§ 371 Date: Mar. 8, 2023

(30) Foreign Application Priority Data
Oct. 14, 2020 (JP) 2020-173251

(51) Int. Cl. G05D 1/02; B60W 40/06; B60W 60/00

(52) U.S. Cl. CPC G05D 1/0214; B60W 40/06; B60W 60/001; G05D 2201/021; B60W 2300/125; B60W 2554/4041; B60W 2554/4044

(57) ABSTRACT

An unmanned vehicle control system includes a travel control unit that outputs a start command for starting the unmanned vehicle, and a management area setting unit that sets a management area where the unmanned vehicle is allowed to move when it is determined that the unmanned vehicle does not start in spite of the start command. The travel control unit outputs an escape command for causing the traveling device of the unmanned vehicle to perform an escape operation in a state where the unmanned vehicle is restricted from moving to the outside of the management area.

### FIELD

The present disclosure relates to an unmanned vehicle control system, an unmanned vehicle, and an unmanned vehicle control method.

### BACKGROUND

An unmanned vehicle operates in a wide-area work site such as a mine. As disclosed in Patent Literature 1, an unmanned vehicle may operate in an oil sand mine. The oil sands refer to sandstones containing a high-viscosity mineral oil component.

### CITATION LIST

### Patent Literature

Patent Literature 1: WO 2016/080555 A

### SUMMARY

### Technical Problem

The oil sand is as soft as a sponge. At least part of a tire of the unmanned vehicle may be buried in the oil sand due to the weight of the unmanned vehicle. When the tire of the unmanned vehicle is buried in the oil sand in the stopped state of the unmanned vehicle, there is a possibility that the start of the unmanned vehicle is difficult. When the unmanned vehicle cannot start or the time required for the tire to escape from the oil sand is long, there is a possibility that the productivity of the work site decreases.

An object of the present disclosure is to suppress a decrease in productivity at a work site where an unmanned vehicle operates.

### Solution to Problem

According to an aspect of the present invention, an unmanned vehicle control system comprises: a travel control unit that outputs a start command for starting an unmanned vehicle; and a management area setting unit that sets a management area in which the unmanned vehicle is allowed to move in a case where it is determined that the unmanned vehicle does not start in spite of the start command, wherein the travel control unit outputs an escape command for causing a traveling device of the unmanned vehicle to perform an escape operation in a state where movement of the unmanned vehicle to an outside of the management area is restricted.

### Advantageous Effects of Invention

According to the present disclosure, a decrease in productivity at a work site where an unmanned vehicle operates is suppressed.

### BRIEF DESCRIPTION OF DRAWINGS

FIG. 1 is a schematic diagram illustrating a work site of an unmanned vehicle according to an embodiment.

FIG. 2 is a schematic diagram illustrating a management system of a work site according to the embodiment.

FIG. 3 is a functional block diagram illustrating a management system of a work site according to the embodiment.

FIG. 4 is a schematic diagram for explaining course data according to the embodiment.

FIG. 5 is a configuration diagram illustrating the unmanned vehicle according to the embodiment.

FIG. 6 is a functional block diagram illustrating an unmanned vehicle control system according to the embodiment.

FIG. 7 is a diagram for describing a start condition according to the embodiment.

FIG. 8 is a view illustrating a state of the unmanned vehicle according to the embodiment.

FIG. 9 is a diagram illustrating a management area according to the embodiment.

FIG. 10 is a diagram for explaining an escape operation of the traveling device according to the embodiment.

FIG. 11 is a diagram illustrating a surrounding situation of the unmanned vehicle before the setting of the management area is started according to the embodiment.

FIG. 12 is a diagram for explaining that course data of another unmanned vehicle is changed according to a notification from the notification unit according to the embodiment.

FIG. 13 is a diagram for explaining that course data of another unmanned vehicle is generated according to a notification from the notification unit according to the embodiment.

FIG. 14 is a flowchart illustrating a control method of the unmanned vehicle according to the embodiment.

FIG. 15 is a diagram for explaining start control according to the embodiment.

### DESCRIPTION OF EMBODIMENTS

Hereinafter, embodiments according to the present disclosure will be described with reference to the drawings, but the present disclosure is not limited to the embodiments. The constituent elements of the respective embodiments described below is allowed to be appropriately combined. In some cases, some components are not used.

[Work Site]

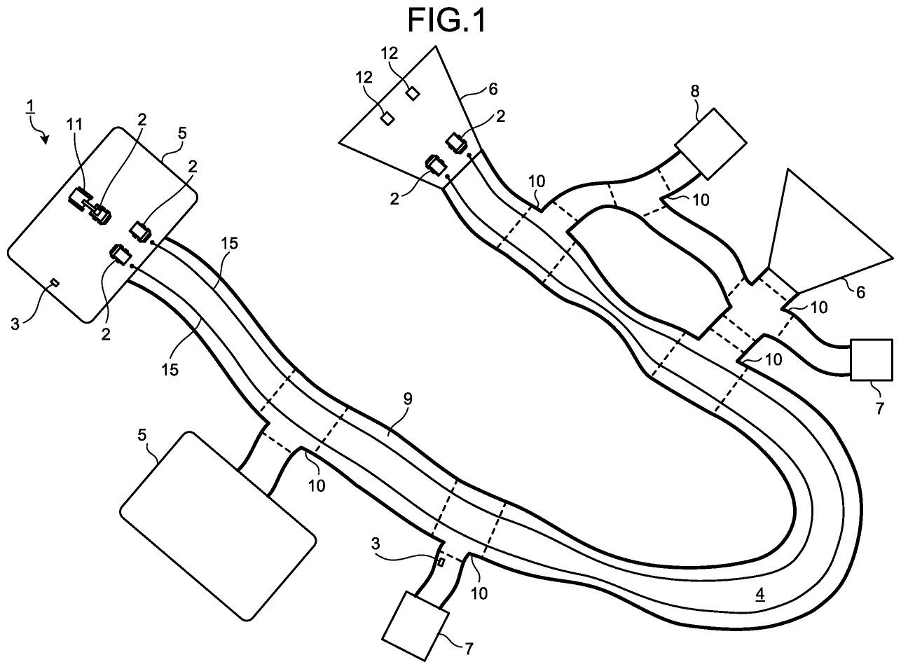

FIG. 1 is a schematic diagram illustrating a work site 1 of an unmanned vehicle 2 according to an embodiment. Examples of the work site 1 include a mine and a quarry. The mine refers to a place or a place of business where minerals are mined. A quarry refers to a place or a place of business where stones are mined. In the work site 1, a plurality of unmanned vehicles 2 is operated. In addition, an auxiliary vehicle 3 operates at the work site 1.

The unmanned vehicle 2 is a work vehicle that operates in an unmanned manner without depending on a driving operation by a driver. The unmanned vehicle 2 is an unmanned dump truck that travels in the work site 1 in an unmanned manner and transports a load. An example of an excavated object excavated at the work site 1 includes the load transported by the unmanned vehicle 2.

The auxiliary vehicle 3 is a manned vehicle that travels in the work site 1 for maintenance, inspection, or management of the work site 1. The manned vehicle refers to a vehicle that operates based on the driving operation of the driver on board.

In the embodiment, the work site 1 is a mine. Examples of the mine include a metal mine for mining metal, a non-metal mine for mining limestone, and a coal mine for mining coal.

A travel area 4 is set at the work site 1. The travel area 4 is an area where the unmanned vehicle 2 can travel. The travel area 4 includes a loading area 5, a discharging area 6, a parking area 7, a fuel filling area 8, a traveling path 9, and an intersection 10.

The loading area 5 is an area in which loading work for loading a load on the unmanned vehicle 2 is performed. In the loading area 5, a loader 11 operates. An example of the loader 11 includes an excavator.

The discharging area 6 is an area where discharging work for discharging a load from the unmanned vehicle 2 is performed. A crusher 12 is provided in the discharging area 6.

The parking area 7 is an area where the unmanned vehicle 2 is parked.

The fuel filling area 8 is an area where the unmanned vehicle 2 is fed.

The traveling path 9 refers to an area where the unmanned vehicle 2 traveling toward at least one of the loading area 5, the discharging area 6, the parking area 7, and the fuel filling area 8 travels. The traveling path 9 is provided so as to connect at least the loading area 5 and the discharging area 6. In the embodiment, the traveling path 9 is connected to each of the loading area 5, the discharging area 6, the parking area 7, and the fuel filling area 8.

The intersection 10 refers to an area where a plurality of traveling paths 9 intersects or an area where one traveling path 9 branches into a plurality of traveling paths 9.

[Management System]

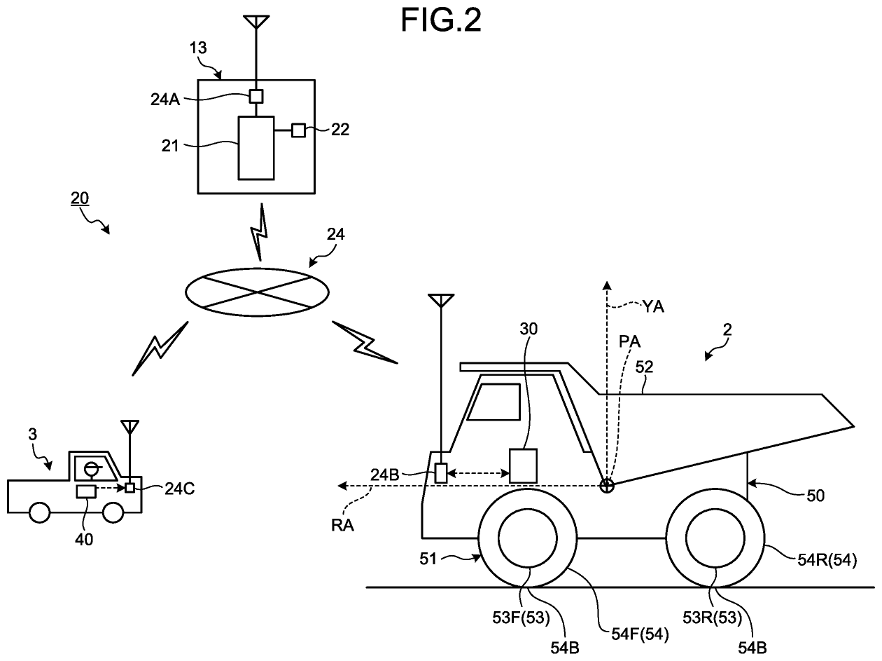

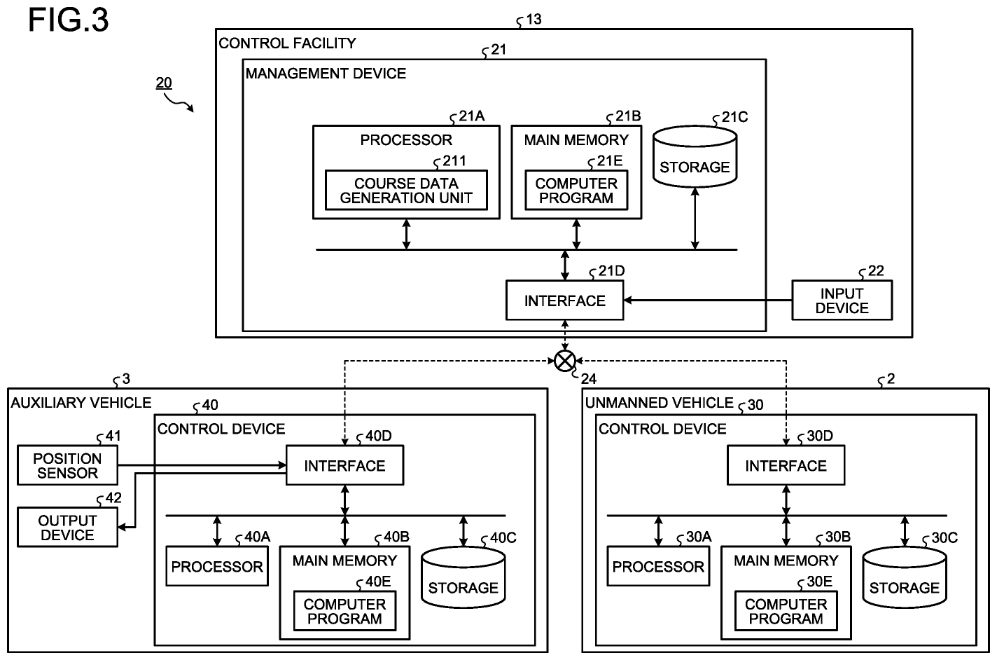

FIG. 2 is a schematic diagram illustrating a management system 20 of the work site 1 according to the embodiment. FIG. 3 is a functional block diagram illustrating the management system 20 of the work site 1 according to the embodiment.

The management system 20 includes a management device 21, an input device 22, and a communication system 24. Each of the management device 21 and the input device 22 is installed in a control facility 13 of the work site 1. An administrator is present in the control facility 13.

The unmanned vehicle 2 includes a control device 30. The auxiliary vehicle 3 includes a control device 40. The management device 21 and the control device 30 of the unmanned vehicle 2 wirelessly communicate with each other via the communication system 24. The management device 21 and the control device 40 of the auxiliary vehicle 3 wirelessly communicate with each other via the communication system 24. A wireless communication device 24A is connected to the management device 21. A wireless communication device 24B is connected to the control device 30. A wireless communication device 24C is connected to the control device 40. The communication system 24 includes the wireless communication device 24A, the wireless communication device 24B, and the wireless communication device 24C.

The input device 22 is operated by the administrator of the control facility 13. The input device 22 is operated by the administrator to generate input data. Examples of the input device 22 include a touch panel, a computer keyboard, a mouse, and an operation button.

The management device 21 includes a computer system. The management device 21 includes a processor 21A, a main memory 21B, a storage 21C, and an interface 21D. Examples of the processor 21A include a central processing unit (CPU) and a micro processing unit (MPU). Examples of the main memory 21B include a nonvolatile memory and a volatile memory is exemplified. An example of the nonvolatile memory includes a read only memory (ROM). An example of the volatile memory includes a random access memory (RAM). Examples of the storage 21C include a hard disk drive (HDD) and a solid state drive (SSD). Examples of the interface 21D include an input/output circuit and a communication circuit.

A computer program 21E is developed in the main memory 21B. The processor 21A executes processing according to the computer program 21E. The interface 21D is connected to the input device 22.

The management device 21 includes a course data generation unit 211.

The course data generation unit 211 generates course data indicating a traveling condition of the unmanned vehicle 2. The course data generation unit 211 generates course data for each of the plurality of unmanned vehicles 2. The administrator of the control facility 13 operates the input device 22 to input the traveling condition of the unmanned vehicle 2 to the management device 21. The course data generation unit 211 generates course data based on the input data generated by the input device 22. The course data generation unit 211 transmits the course data to the unmanned vehicle 2 via the communication system 24.

The unmanned vehicle 2 operates at the work site 1 based on the course data transmitted from the management device 21.

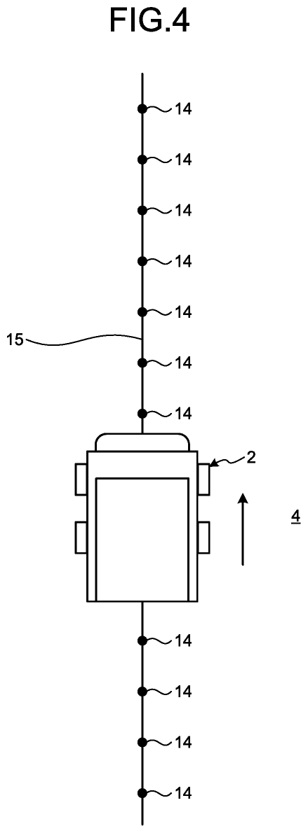

FIG. 4 is a schematic diagram for explaining course data according to the embodiment. The course data defines the traveling condition of the unmanned vehicle 2. The course data includes a course point 14, a travel course 15, a target position of the unmanned vehicle 2, a target traveling speed of the unmanned vehicle 2, a target azimuth of the unmanned vehicle 2, and a topography at the course point 14.

A plurality of course points 14 is set in the travel area 4. The course point 14 defines a target position of the unmanned vehicle 2. The target traveling speed of the unmanned vehicle 2 and the target azimuth of the unmanned vehicle 2 are set in each of the plurality of course points 14. The plurality of course points 14 is set at intervals. The interval between the course points 14 is set to, for example, 1 [m] or more and 5 [m] or less. The intervals between the course points 14 may be uniform or non-uniform.

The travel course 15 refers to a virtual line indicating a target travel route of the unmanned vehicle 2. The travel course 15 is defined by a trajectory passing through the plurality of course points 14. The unmanned vehicle 2 travels in the travel area 4 according to the travel course 15.

The target position of the unmanned vehicle 2 refers to a target position of the unmanned vehicle 2 when passing through the course point 14. The target position of the unmanned vehicle 2 may be defined in a local coordinate system of the unmanned vehicle 2 or may be defined in a global coordinate system.

The target traveling speed of the unmanned vehicle 2 refers to a target traveling speed of the unmanned vehicle 2 when passing through the course point 14.

The target azimuth of the unmanned vehicle 2 refers to a target azimuth of the unmanned vehicle 2 when passing through the course point 14.

The topography at the course point 14 refers to an inclination angle of the surface of the travel area 4 at the course point 14.

[Auxiliary Vehicle]

As illustrated in FIGS. 2 and 3, the auxiliary vehicle 3 includes the control device 40, the wireless communication device 24C, a position sensor 41, and an output device 42.

The control device 40 includes a computer system. The control device 40 includes a processor 40A, a main memory 40B, a storage 40C, and an interface 40D. A computer program 40E is developed in the main memory 40B. The interface 40D is connected to each of the position sensor 41 and the output device 42.

The position sensor 41 detects the position of the auxiliary vehicle 3. The position of the auxiliary vehicle 3 is detected using a global navigation satellite system (GNSS). The global navigation satellite system includes a global positioning system (GPS). The global navigation satellite system detects a position in a global coordinate system defined by coordinate data of latitude, longitude, and altitude. The global coordinate system refers to a coordinate system fixed to the earth. The position sensor 41 includes a GNSS receiver and detects the position of the auxiliary vehicle 3 in the global coordinate system.

The output device 42 is disposed in the cab of the auxiliary vehicle 3. The output device 42 outputs output data. Examples of the output device 42 include a display device and a voice output device. Examples of the display device include a flat panel display such as a liquid crystal display or an organic electroluminescent display.

[Unmanned Vehicle]

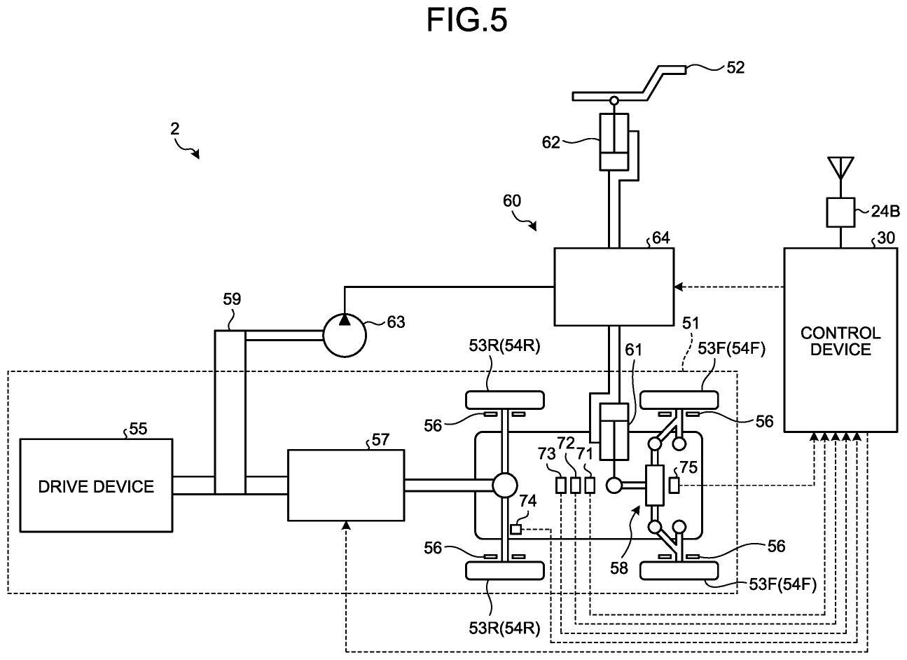

FIG. 5 is a configuration diagram illustrating the unmanned vehicle 2 according to the embodiment. As illustrated in FIGS. 2, 3, and 5, the unmanned vehicle 2 includes the control device 30, the wireless communication device 24B, a vehicle body 50, a traveling device 51, a dump body 52, a hydraulic device 60, a position sensor 71, an azimuth sensor 72, an inclination sensor 73, a speed sensor 74, and a steering sensor 75.

As illustrated in FIG. 2, the local coordinate system of the unmanned vehicle 2 is defined by the pitch axis PA, the roll axis RA, and the yaw axis YA. The pitch axis PA extends in the left-right direction (vehicle width direction) of the unmanned vehicle 2. The roll axis RA extends in the front-rear direction of the unmanned vehicle 2. The yaw axis YA extends in the vertical direction of the unmanned vehicle 2. The pitch axis PA and the roll axis RA are orthogonal to each other. The roll axis RA and the yaw axis YA are orthogonal to each other. The yaw axis YA and the pitch axis PA are orthogonal to each other.

The control device 30 includes a computer system. As illustrated in FIG. 3, the control device 30 includes a processor 30A, a main memory 30B, a storage 30C, and an interface 30D. A computer program 30E is developed in the main memory 30B.

The vehicle body 50 includes a vehicle body frame. The vehicle body 50 is supported by the traveling device 51. The vehicle body 50 supports the dump body 52.

The traveling device 51 causes the unmanned vehicle 2 to travel. The traveling device 51 moves the unmanned vehicle 2 forward or backward. At least part of the traveling device 51 is disposed below the vehicle body 50. The traveling device 51 includes wheels 53, tires 54, a drive device 55, a brake device 56, a transmission device 57, and a steering device 58.

The tire 54 is mounted on the wheel 53. The wheels 53 includes a front wheel 53F and a rear wheel 53R. The tires 54 includes a front tire 54F mounted on the front wheel 53F and a rear tire 54R mounted on the rear wheel 53R.

The drive device 55 generates a driving force for starting or accelerating the unmanned vehicle 2. Examples of the drive device 55 include an internal combustion engine and an electric motor. An example of the internal combustion engine includes a diesel engine.

The brake device 56 generates a braking force for stopping or decelerating the unmanned vehicle 2. Examples of the brake device 56 include a disc brake and a drum brake.

The transmission device 57 transmits the driving force generated by the drive device 55 to the wheel 53. Transmission device 57 includes a forward clutch and a backward clutch. When the connection state between the forward clutch and the backward clutch is switched, the forward movement and the backward movement of the unmanned vehicle 2 are switched. The wheel 53 is rotated by a driving force generated by the drive device 55. When the wheel 53 rotates in a state where the tire 54 is in contact with the road surface of the work site, the unmanned vehicle 2 travels in the work site 1.

The steering device 58 generates a steering force for adjusting the traveling direction of the unmanned vehicle 2. The traveling direction of the unmanned vehicle 2 moving forward refers to an azimuth toward the front portion of the vehicle body 50. The traveling direction of the unmanned vehicle 2 traveling backward refers to an azimuth toward the rear portion of the vehicle body 50. The steering device 58 steers the wheel 53. The traveling direction of the unmanned vehicle 2 is adjusted by steering the wheel 53.

The wheel 53 includes a drive wheel to which the driving force from the drive device 55 is transmitted and a steering wheel steered by the steering device 58. In the embodiment, the drive wheel is the rear wheel 53R. The steering wheel is the front wheel 53F.

The dump body 52 is a member on which a load is loaded. At least part of the dump body 52 is disposed above the vehicle body 50. The dump body 52 performs a dumping operation and a lowering operation. The dump body 52 is adjusted to the dump posture and the loading posture by the dumping operation and the lowering operation. The dump posture refers to a posture in which the dump body 52 is raised. The loading posture refers to a posture in which the dump body 52 is lowered.

The hydraulic device 60 includes a steering cylinder 61, a hoist cylinder 62, a hydraulic pump 63, and a valve device 64.

The steering cylinder 61 generates a steering force for steering the front wheel 53F in the steering device 58. The steering cylinder 61 is a hydraulic cylinder. The steering device 58 includes the steering cylinder 61. The front wheel 53F is connected to the steering cylinder 61 via a link mechanism of the steering device 58. When the steering cylinder 61 is expanded and contracted, the front wheel 53F is steered.

The hoist cylinder 62 generates a lifting force for operating the dump body 52. The hoist cylinder 62 is a hydraulic cylinder. The dump body 52 is connected to the hoist cylinder 62. When the hoist cylinder 62 is expanded and contracted, the dump body 52 performs a dumping operation and a lowering operation.

The hydraulic pump 63 is operated by the driving force generated by the drive device 55. Part of the driving force generated by the drive device 55 is transmitted to the hydraulic pump 63 via a power transmission mechanism 59. The hydraulic pump 63 discharges hydraulic oil for expanding and contracting each of the steering cylinder 61 and the hoist cylinder 62.

The valve device 64 adjusts a flowing state of the hydraulic oil supplied to each of the steering cylinder 61 and the hoist cylinder 62. The valve device 64 operates based on a control command from the control device 30. The valve device 64 includes a first flow rate regulating valve capable of adjusting the flow rate and the direction of the hydraulic oil supplied to the steering cylinder 61 and a second flow rate regulating valve capable of adjusting the flow rate and the direction of the hydraulic oil supplied to the hoist cylinder 62. The steering cylinder 61 is expanded and contracted by hydraulic oil supplied from the hydraulic pump 63 via the valve device 64. The hoist cylinder 62 is expanded and contracted by the hydraulic oil supplied from the hydraulic pump 63 via the valve device 64.

The position sensor 71 detects the position of the unmanned vehicle 2. The position of the unmanned vehicle 2 is detected using a global navigation satellite system (GNSS). The position sensor 71 includes a GNSS receiver and detects the position of the unmanned vehicle 2 in the global coordinate system.

The azimuth sensor 72 detects an azimuth of the unmanned vehicle 2. The azimuth of the unmanned vehicle 2 includes a yaw angle Yθ of the unmanned vehicle 2. The yaw angle Yθ refers to an inclination angle of the unmanned vehicle 2 around the yaw axis YA. An example of the azimuth sensor 72 includes a gyro sensor.

The inclination sensor 73 detects a posture of the unmanned vehicle 2. The posture of the unmanned vehicle 2 includes an inclination angle of the vehicle body 50. The inclination angle of the vehicle body 50 includes a pitch angle Pθ and a roll angle RO of the vehicle body 50. The pitch angle Pθ refers to an inclination angle of the vehicle body 50 about the pitch axis PA. The roll angle Rθ refers to an inclination angle of the vehicle body 50 about the roll axis RA. An example of the inclination sensor 73 includes an inertial measurement unit (IMU).

In a state where a lower end portion 54B of the tire 54 is in contact with the ground parallel to the horizontal plane, each of the pitch axis PA and the roll axis RA is parallel to the horizontal plane. In a state where a lower end portion 54B of the tire 54 is in contact with the ground parallel to the horizontal plane, each of the pitch angle Pθ and the roll angle Rθ is 0 [°]. The lower end portion 54B of the tire 54 refers to part of the outer peripheral face of the tire 54 disposed at the lowermost side in the vertical direction parallel to the yaw axis YA.

The speed sensor 74 detects a traveling speed of the unmanned vehicle 2. An example of the speed sensor 74 includes a pulse sensor that detects rotation of the wheel 53.

The steering sensor 75 detects a steering angle of the steering device 58. An example of the steering sensor 75 includes a potentiometer.

The control device 30 is disposed in the vehicle body 50. The control device 30 outputs a control command for controlling the traveling device 51. The control command output from the control device 30 includes a drive command for operating the drive device 55, a brake command for operating the brake device 56, a forward/backward movement command for operating the transmission device 57, and a steering command for operating the steering device 58. The drive device 55 generates a driving force for starting or accelerating the unmanned vehicle 2 based on the drive command output from the control device 30. The brake device 56 generates a braking force for stopping or decelerating the unmanned vehicle 2 based on the brake command output from the control device 30. The transmission device 57 switches between forward movement and backward movement of the unmanned vehicle 2 based on the forward/backward movement command output from the control device 30. The steering device 58 generates a steering force for causing the unmanned vehicle 2 to travel straight or swing on the basis of the steering command output from the control device 30.

[Control System]

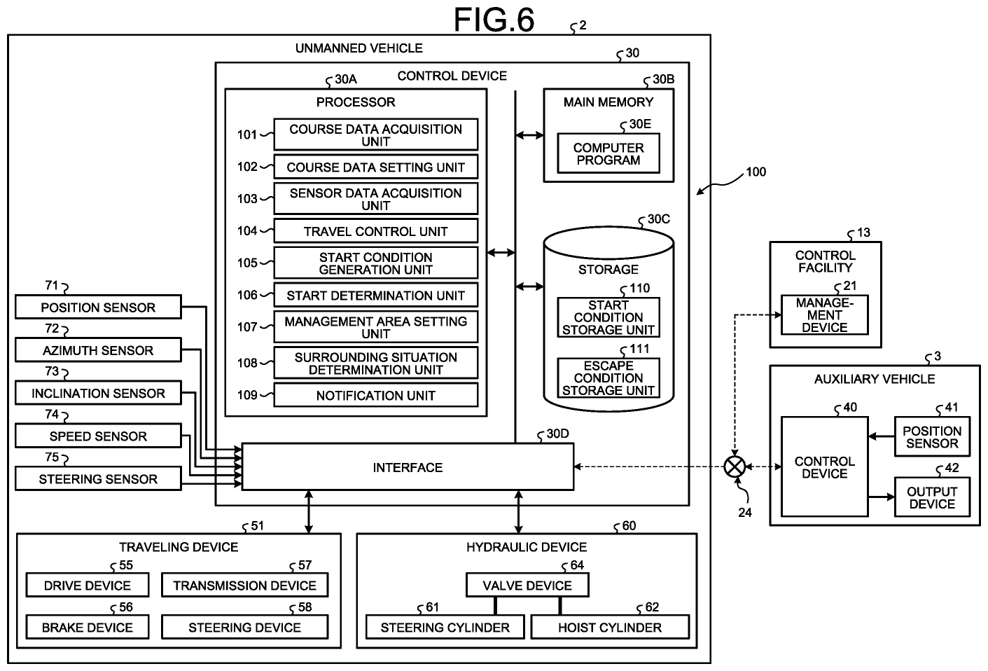

FIG. 6 is a functional block diagram illustrating a control system 100 of the unmanned vehicle 2 according to the embodiment. The control system 100 includes the control device 30, the traveling device 51, the hydraulic device 60, the position sensor 71, the azimuth sensor 72, the inclination sensor 73, the speed sensor 74, and the steering sensor 75.

The interface 30D is connected to each of the traveling device 51, the hydraulic device 60, the position sensor 71, the azimuth sensor 72, the inclination sensor 73, the speed sensor 74, and the steering sensor 75.

The control device 30 includes a course data acquisition unit 101, a course data setting unit 102, a sensor data acquisition unit 103, a travel control unit 104, a start condition generation unit 105, a start determination unit 106, a management area setting unit 107, a surrounding situation determination unit 108, a notification unit 109, a start condition storage unit 110, and an escape condition storage unit 111.

The processor 30A functions as the course data acquisition unit 101, the course data setting unit 102, the sensor data acquisition unit 103, the travel control unit 104, the start condition generation unit 105, the start determination unit 106, the management area setting unit 107, the surrounding situation determination unit 108, and the notification unit 109. The storage 30C functions as the start condition storage unit 110 and the escape condition storage unit 111.

The course data acquisition unit 101 acquires the course data transmitted from the course data generation unit 211 via the interface 30D. When the course data generation unit 211 updates the course data, the course data acquisition unit 101 acquires the updated course data. The course data acquisition unit 101 acquires course data each time the course data is updated.

The course data setting unit 102 switches between enabling and disabling of the course travel control performed based on the course data. The course travel control refers to travel control of the traveling device 51 performed based on the course data. The course travel control of the traveling device 51 includes course following control for causing the unmanned vehicle 2 to follow the travel course 15. When the course travel control is enabled, the unmanned vehicle 2 travels according to the course data. When the course travel control is disabled, the unmanned vehicle 2 travels without following the course data. The course data is acquired by the course data acquisition unit 101. The course data acquired by the course data acquisition unit 101 is constantly enabled. The enabling and disabling of the course travel control performed based on the course data are switched.

The sensor data acquisition unit 103 acquires detection data of the position sensor 71, detection data of the azimuth sensor 72, detection data of the inclination sensor 73, detection data of the speed sensor 74, and detection data of the steering sensor 75.

The travel control unit 104 performs course travel control of the unmanned vehicle 2. When the course travel control is enabled, the travel control unit 104 performs the course travel control of the traveling device 51 based on the course data.

The travel control unit 104 performs course travel control of the traveling device 51 so that the unmanned vehicle 2 travels along the travel course 15 in a state where the course travel control is enabled. In the embodiment, the travel control unit 104 performs the course travel control of the traveling device 51 so that the unmanned vehicle 2 travels in a state where the center of the unmanned vehicle 2 in the vehicle width direction matches the travel course 15.

The travel control unit 104 performs the course travel control of the traveling device 51 so that the actual position of the unmanned vehicle 2 when passing through the course point 14 is the target position based on the detection data of the position sensor 71 in a state in which the course travel control is enabled. The travel control unit 104 performs course travel control of the traveling device 51 so that the unmanned vehicle 2 travels along the travel course 15 based on the detection data of the position sensor 71.

The travel control unit 104 performs the course travel control of the traveling device 51 so that the actual azimuth of the unmanned vehicle 2 when passing through the course point 14 is the target azimuth based on the detection data of the azimuth sensor 72 in a state in which the course travel control is enabled. The travel control unit 104 performs the course travel control of the traveling device 51 so that there is no deviation between the actual position of the unmanned vehicle 2 and the target position of the unmanned vehicle 2 defined by the course point 14 and so that the actual azimuth of the unmanned vehicle 2 when passing through the course point 14 is the target azimuth.

In each of the state in which the course travel control is enabled and the state in which the course travel control is disabled, the travel control unit 104 calculates the posture of the unmanned vehicle 2 at the course point 14 based on the detection data of the inclination sensor 73 when the unmanned vehicle 2 passes through the course point 14 and the topography at the course point 14.

The travel control unit 104 performs the course travel control of the traveling device 51 so that the actual traveling speed of the unmanned vehicle 2 when passing through the course point 14 is the target traveling speed based on the detection data of the speed sensor 74 in a state in which the course travel control is enabled.

The travel control unit 104 performs the course travel control of the traveling device 51 so that the actual steering angle of the unmanned vehicle 2 when passing through the course point 14 is the target steering angle based on the detection data of the steering sensor 75 in a state in which the course travel control is enabled.

In addition, the travel control unit 104 performs start control of the unmanned vehicle 2. The start control refers to control for starting the unmanned vehicle 2 in the stopped state. In the embodiment, the start control refers to travel control of the traveling device 51 performed based on a predetermined start condition.

In the start control, the travel control unit 104 outputs a start command Ca for starting the unmanned vehicle 2 in a predetermined movement direction. In the embodiment, the predetermined movement direction is the front direction of the unmanned vehicle 2. That is, the start command Ca moves the unmanned vehicle 2 forward.

The start condition generation unit 105 generates a start condition used for start control of the unmanned vehicle 2. The start condition includes a control program related to start control. The start condition generated by the start condition generation unit 105 is stored in the start condition storage unit 110. The travel control unit 104 performs start control of the unmanned vehicle 2 based on the start condition stored in the start condition storage unit 110.

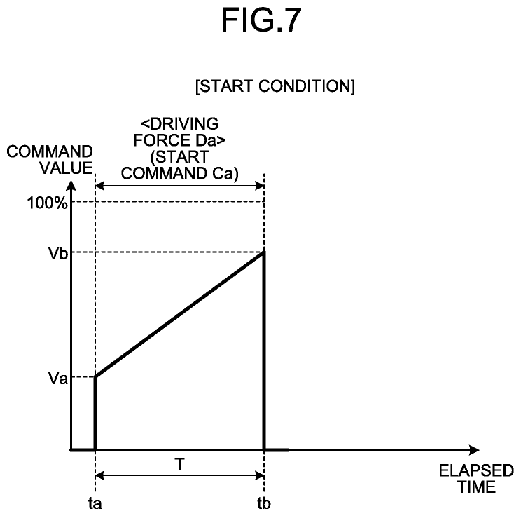

FIG. 7 is a diagram for describing a start condition according to the embodiment. When the unmanned vehicle 2 is started, the start command Ca is output from the travel control unit 104. In FIG. 7, the vertical axis represents the command value of the start command Ca, and the horizontal axis represents the elapsed time from a time point ta at which the output of the start command Ca is started. The time point ta is a start time point of the start control by the start command Ca. The start condition indicates a relationship between the start command Ca for starting the unmanned vehicle 2 and the elapsed time from the time point ta of the start control. The start command Ca is output for a specified time T from the time point ta to a time point tb. The time point tb is an end time point of the start control by the start command Ca.

The start command Ca includes a drive command for causing the drive device 55 of the unmanned vehicle 2 to generate a driving force Da. The larger the command value of the start command Ca, the larger the driving force Da generated by the drive device 55, and the smaller the command value of the start command Ca, the smaller the driving force Da generated by the drive device 55. When the command value is 100 [%], the drive device 55 outputs the maximum value of the driving force that the drive device 55 is allowed to generate. That is, when the command value is 100 [%], the drive device 55 operates in the full accelerator state.

In the example illustrated in FIG. 7, the start condition is set so that the command value of the start command Ca does not reach 100 [%]. A command value Va of the start command Ca at the time point ta is smaller than 50 [%]. The command value Va of the start command Ca at the time point ta may be 50 [%] or larger than 50 [%]. A command value Vb of the start command Ca at the time point tb is larger than the command value Va and smaller than 100 [%]. The command value of the start command Ca is set so as to monotonically increase from the time point ta to the time point tb. The output of the start command Ca is stopped at the time point tb when the specified time T has elapsed since the start of the output of the start command Ca.

The command value Va of the start command Ca is calculated so that the unmanned vehicle 2 in the stopped state starts at the time point ta. The start condition generation unit 105 calculates the target acceleration of the unmanned vehicle 2 based on the target traveling speed of the unmanned vehicle 2 defined by the course data. The start condition generation unit 105 calculates the target driving force of the drive device 55 that generates the target acceleration based on the motion equation obtained by modeling each of the unmanned vehicle 2 and the travel area 4. Correlation data (table) indicating the relationship between the target driving force and the command value is determined in advance. The start condition generation unit 105 determines the command value Va for generating the target driving force at the time point ta based on the correlation data.

When the start control is performed based on the start condition, the travel control unit 104 starts outputting the start command Ca at the time point ta. When the start command Ca is output, the unmanned vehicle 2 can start. The drive device 55 generates the driving force Da based on the start command Ca.

The command value Va at the time point ta is a theoretical value calculated based on the motion equation described above. For example, there is a possibility that the unmanned vehicle 2 cannot start at the time point ta even when the output of the start command Ca is started due to the actual state of the unmanned vehicle 2 or the actual state of the travel area 4. In the embodiment, since the command value of the start command Ca monotonously increases from the time point ta to the time point tb, the unmanned vehicle 2 can start at the specified time T.

The command value of the start command Ca may reach 100 [%]. For example, the command value Vb of the start command Ca at the time point tb may be 100 [%]. The command value Va of the start command Ca at the time point ta may be 100 [%].

The start determination unit 106 determines whether the unmanned vehicle 2 has started in response to the start command Ca. The start determination unit 106 determines whether the unmanned vehicle 2 has started based on the specified time T and the detection data of the speed sensor 74. The start determination unit 106 can determine whether the unmanned vehicle 2 has started acceleration based on the detection data of the speed sensor 74. When it is determined that the unmanned vehicle 2 has started accelerating in the specified time T, the start determination unit 106 determines that the unmanned vehicle 2 has started. When it is determined that the unmanned vehicle 2 does not start accelerating in the specified time T, the start determination unit 106 determines that the unmanned vehicle 2 does not start.

Note that the start determination unit 106 may determine whether the unmanned vehicle 2 has started based on the traveling speed of the unmanned vehicle 2, the acceleration of the unmanned vehicle 2, and the movement distance of the unmanned vehicle 2. The start determination unit 106 may estimate the traveling speed of the unmanned vehicle 2 from at least one piece of detection data of the detection data of the speed sensor 74 including the pulse sensor, the detection data of the position sensor 71 including the GNSS receiver, and the detection data of the inclination sensor 73 including the inertial measurement unit. The start determination unit 106 may determine whether the unmanned vehicle 2 has started in consideration of the skid situation of the tire 54.

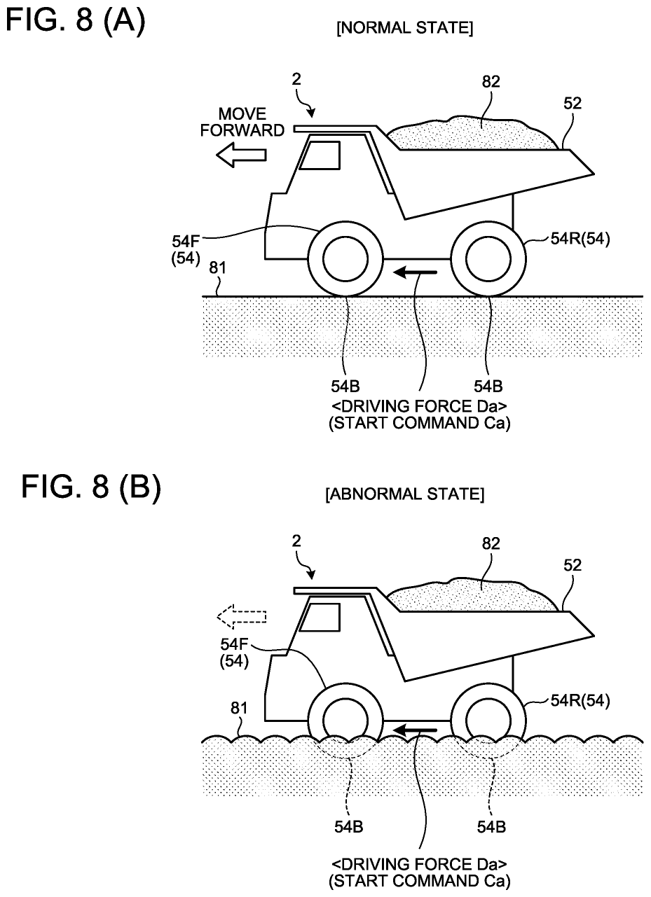

FIG. 8 is a view illustrating a state of the unmanned vehicle 2 according to the embodiment. The state of the unmanned vehicle 2 includes a normal state and an abnormal state.

As illustrated in FIG. 8(A), the normal state of the unmanned vehicle 2 includes a state in which the lower end portion 54B of the tire 54 is in contact with a road surface 81. That is, the normal state of the unmanned vehicle 2 refers to a state in which the tire 54 is not buried under a road surface 81 or a state in which the tire 54 does not enter a groove present in the road surface 81. When the road surface 81 is stiff, the unmanned vehicle 2 is likely to be in a normal state.

As illustrated in FIG. 8(B), the abnormal state of the unmanned vehicle 2 includes a state in which at least part of the tire 54 is buried under the road surface 81 or a state in which the tire enters a groove present in the road surface 81. When the road surface 81 is soft, the unmanned vehicle 2 is highly likely to be in an abnormal state. In addition, in a case where a load 82 is loaded on the dump body 52 and the weight of the unmanned vehicle 2 is large, the unmanned vehicle 2 is highly likely to be in an abnormal state. Examples of the soft road surface 81 include a road surface of the oil sand and a road surface muddy by rainwater.

The start condition illustrated in FIG. 7 is a start condition used when the unmanned vehicle 2 is in the normal state. That is, the start command Ca is used when the unmanned vehicle 2 in the normal state is started. When the unmanned vehicle 2 is in an abnormal state, there is a possibility that the unmanned vehicle 2 does not start in spite of the start command Ca.

In addition, when the unmanned vehicle 2 does not start in spite of the start command Ca, the travel control unit 104 performs the escape control of the unmanned vehicle 2. The escape control refers to control for causing the traveling device 51 to perform an escape operation different from the start operation to start the unmanned vehicle 2. In the embodiment, the escape control refers to travel control of the traveling device 51 performed based on a predetermined escape condition.

When the start determination unit 106 determines that the unmanned vehicle 2 does not start in spite of the start command Ca, the management area setting unit 107 sets a management area 83 where the unmanned vehicle 2 is allowed to move.

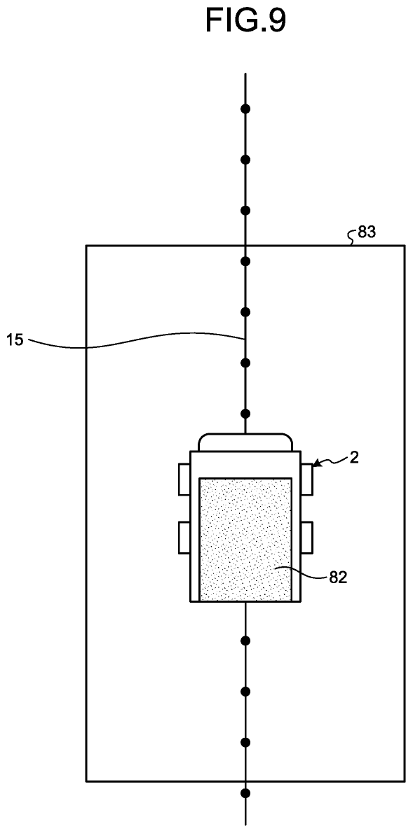

FIG. 9 is a diagram illustrating the management area 83 according to the embodiment. When it is determined that the unmanned vehicle 2 does not start in spite of the start command Ca, the management area setting unit 107 sets the management area 83 where the unmanned vehicle 2 is allowed to move. The management area 83 is set to include the unmanned vehicle 2. The edge of the management area 83 is disposed around the unmanned vehicle 2.

In the example illustrated in FIG. 9, the outer shape of the management area 83 is a quadrangle. Note that the outer shape of the management area 83 may be a pentagon, a hexagon, or a polygon having a heptagon or more. The outer shape of the management area 83 may be circular or elliptical. The management area 83 may be defined by any curve.

The management area setting unit 107 sets the management area 83 so that the edge of the management area 83 is disposed around the unmanned vehicle 2 at the time point when the start determination unit 106 determines that the unmanned vehicle 2 does not start.

When the management area 83 is set, the unmanned vehicle 2 is restricted from moving to the outside of the management area 83.

The travel control unit 104 performs the escape control of the unmanned vehicle 2 after the management area 83 is set. The travel control unit 104 outputs an escape command Ce for causing the traveling device 51 of the unmanned vehicle 2 to perform an escape operation in a state where the unmanned vehicle 2 is restricted from moving to the outside of the management area 83. The escape operation of the traveling device 51 according to the escape command Ce is different from the start operation of the traveling device 51 according to the start command Ca.

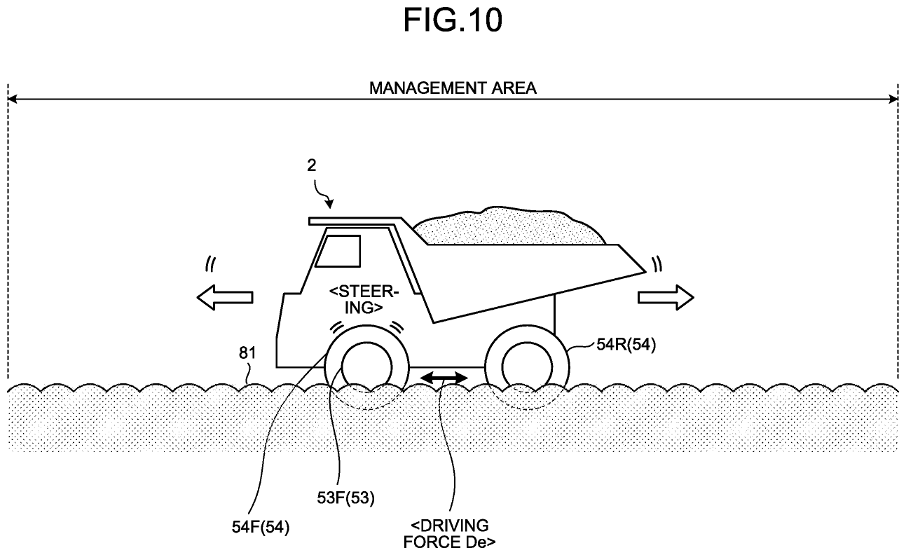

FIG. 10 is a diagram for describing the escape operation of the traveling device 51 according to the embodiment. The escape operation refers to an operation of causing the tire 54 to escape from the buried state in a buried state in which at least part of the tire 54 is buried under the road surface 81 or enters a groove present in the road surface 81. When at least part of the tire 54 is buried under the road surface 81, the travel control unit 104 causes the traveling device 51 to perform an escape operation for causing the tire 54 to escape from the buried state. The traveling device 51 performs the escape operation based on the escape command Ce output from the travel control unit 104. The travel control unit 104 outputs the escape command Ce in a state where the course travel control is disabled.

The escape command Ce includes a control command for starting the unmanned vehicle 2 that was not able to start in spite of the start command Ca. The escape command Ce includes a drive command for causing the drive device 55 to generate a driving force De for starting the unmanned vehicle 2. The driving force De output by the escape command Ce may be equal to or larger than the driving force Da output by the start command Ca. In the embodiment, the driving force De is the maximum value of the driving force that the drive device 55 of the unmanned vehicle 2 is allowed to generate. That is, the command value of the escape command Ce is 100 [%].

When the unmanned vehicle 2 was not able to start in spite of the start command Ca, the travel control unit 104 outputs the escape command Ce for starting the unmanned vehicle 2 to the traveling device 51 in a state where the management area 83 is set. The travel control unit 104 causes the traveling device 51 to perform an escape operation so that the unmanned vehicle 2 does not go out of the management area 83. Since the course travel control is disabled, the travel control unit 104 can freely move the unmanned vehicle 2 inside the management area 83. When the position of the edge of the management area 83 is defined in the global coordinate system, the travel control unit 104 outputs the escape command Ce so that the unmanned vehicle 2 does not go out of the management area 83 based on the detection data of the position sensor 71.

An escape condition defining an escape operation is stored in the escape condition storage unit 111. The escape condition indicates the content and order of the escape operation to be performed by the traveling device 51 in order to escape the tire 54 from the buried state. The escape condition is defined based on an empirical rule that allows the tire 54 to escape from the buried state. The travel control unit 104 outputs the escape command Ce based on the escape condition stored in the escape condition storage unit 111. The traveling device 51 performs the escape operation according to the escape condition.

As described above, the start command Ca is a control command for starting the unmanned vehicle 2 in a predetermined movement direction. The escape operation of the traveling device 51 includes an operation of traveling in a direction opposite to the movement direction of the unmanned vehicle 2. When the start command Ca is a control command for moving the unmanned vehicle 2 forward, the escape command Ce is a control command for moving the unmanned vehicle 2 backward. The escape operation of the traveling device 51 includes an operation of moving the unmanned vehicle 2 backward. When the unmanned vehicle 2 was not able to move forward in spite of the start command Ca, the unmanned vehicle 2 moves backward based on the escape command Ce, whereby the tire 54 can escape from the buried state. When the start command Ca is a control command to move the unmanned vehicle 2 backward, the escape command Ce is a control command to move the unmanned vehicle 2 forward.

Note that the escape operation of the traveling device 51 may be an operation of repeating forward movement and backward movement. When the unmanned vehicle 2 was not able to move forward in spite of the start command Ca, the tire 54 can escape from the buried state by causing the unmanned vehicle 2 to repeat forward movement and backward movement based on the escape command Ce.

The escape operation of the traveling device 51 may be an operation of changing the steering angle of the front wheel 53F in a state where the driving force De for starting the unmanned vehicle 2 is generated. The front wheel 53F is allowed to be steered in a prescribed steering range. The travel control unit 104 may output the escape command Ce to the steering device 58 so that the front wheel 53F reciprocates in the steering range. The travel control unit 104 may output the escape command Ce so that the front wheel 53F reciprocates between one end and the other end of the steering range, or may output the escape command Ce so that the front wheel 53F reciprocates in a partial range of the steering range. The front wheel 53F may not reciprocate in the steering range. The travel control unit 104 may output the escape command Ce so that the front wheel 53F moves from one end to the other end of the steering range. The steering speed of the front wheel 53F may be constant or random. The steering speed of the front wheel 53F may be, for example, a speed corresponding to the maximum value of the cylinder speed that the steering cylinder 61 is allowed to generate, or may be a speed corresponding to a value of 1 [%] or more to 50 [%] or less of the maximum value of the cylinder speed.

Even when the tire 54 is in the buried state, the tire 54 can escape from the buried state by the traveling device 51 performing the escape operation different from the start operation. Therefore, the unmanned vehicle 2 can start.

In the embodiment, after it is determined that the unmanned vehicle 2 does not start in spite of the start command Ca and the management area 83 is set, the course data setting unit 102 disables the course travel control and enables the escape control. After the course travel control is disabled and the escape control is disabled, the travel control unit 104 performs the escape control of the traveling device 51 based on the escape condition. When the course travel control is disabled, the travel control unit 104 performs the escape control of the traveling device 51 so that the unmanned vehicle 2 moves inside the management area 83 regardless of the course data.

After it is determined that the unmanned vehicle 2 has started in response to the escape command Ce, the course data setting unit 102 disables the escape control and enables the course travel control. After the escape control is disabled and the course travel control is disabled, the travel control unit 104 performs the course travel control of the traveling device 51 based on the course data. The management area setting unit 107 cancels the management area 83 after the deviation between the actual position of the unmanned vehicle 2 after starting and the travel course 15 is less than or equal to a predetermined allowable value.

In the embodiment, the distance from the center of the unmanned vehicle 2 to the edge of the management area 83 is determined to be a distance sufficient to determine whether the unmanned vehicle 2 starts by the escape command Ce and a distance sufficient to make the deviation between the actual position of the unmanned vehicle 2 after starting by the escape control and the travel course 15 equal to or less than the allowable value. As an example, the distance from the center of the unmanned vehicle 2 to the edge of the management area 83 is 5 [m] or more and 30 [m] or less. In the embodiment, 15 [m] is set as the distance for determining whether the unmanned vehicle 2 starts by the escape command Ce, and 15 [m] is set as the distance for making the deviation between the actual position of the unmanned vehicle 2 after the start and the travel course 15 equal to or less than the allowable value. That is, the distance from the center of the unmanned vehicle 2 to the edge of the management area 83 is 30 [m].

The surrounding situation determination unit 108 determines whether the setting of the management area 83 is allowed to be started based on the surrounding situation of the unmanned vehicle 2 before the setting of the management area 83 is started. The management area setting unit 107 sets the management area 83 based on the result of determination by the surrounding situation determination unit 108.

An example of the surrounding situation includes a position of a moving object around the unmanned vehicle 2 with respect to the management area 83. Examples of the moving object include an another unmanned vehicle 2A and the auxiliary vehicle 3. In addition, an example of the surrounding situation includes a position of a non-moving object around the unmanned vehicle 2 with respect to the management area 83. Examples of the non-moving object include an electric light, a stone, a bank, a fuel supply facility, and a sign present at a work site. In addition, an example of the surrounding situation includes course data of the another unmanned vehicle 2A around the unmanned vehicle 2 with respect to the management area 83.

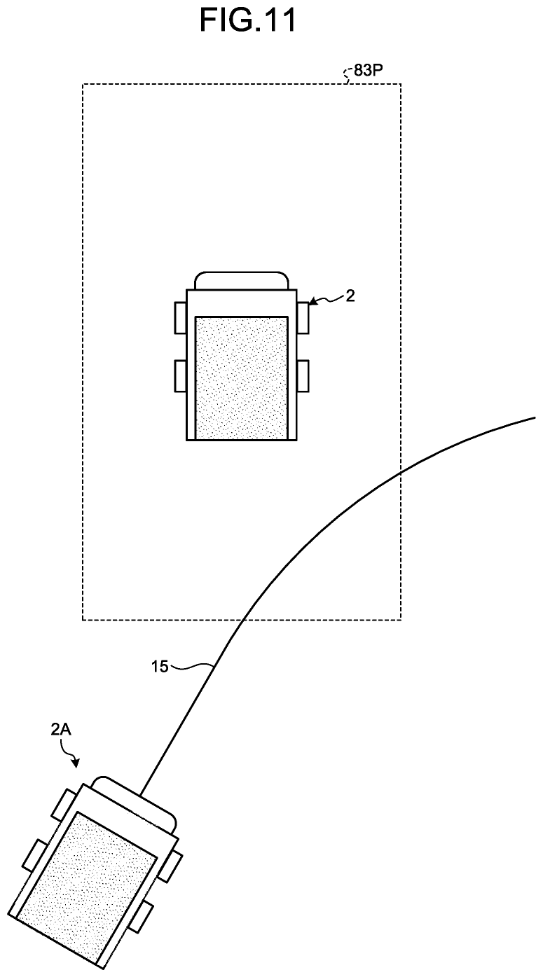

FIG. 11 is a diagram illustrating a surrounding situation of the unmanned vehicle 2 before the setting of the management area 83 is started according to the embodiment. FIG. 11 illustrates an example in which the surrounding situation is course data of the another unmanned vehicle 2A. As illustrated in FIG. 11, there is a possibility that the travel course 15 of the another unmanned vehicle 2A is provided in a scheduled area 83P of the management area 83 before the setting of the management area 83 is started. The scheduled area 83P is an area for which setting of the management area 83 is scheduled. When the setting of the management area 83 is started in a state where the travel course 15 is provided in the scheduled area 83P, there is a possibility that traveling of the another unmanned vehicle 2A is hindered by the unmanned vehicle 2 moving in the management area 83. As a result, productivity at the work site may be reduced.

The surrounding situation determination unit 108 acquires the course data of the another unmanned vehicle 2A from the course data generation unit 211. When the travel course 15 of the another unmanned vehicle 2A is not provided in the scheduled area 83P, the surrounding situation determination unit 108 determines that the setting of the management area 83 is allowed to be started. When the travel course 15 of the another unmanned vehicle 2A is provided in the scheduled area 83P, the surrounding situation determination unit 108 determines that the setting of the management area 83 is not allowed to be started. When the surrounding situation determination unit 108 determines that the setting of the management area 83 is allowed to be started, the management area setting unit 107 sets the management area 83. When the surrounding situation determination unit 108 determines that the setting of the management area 83 is not allowed to be started, the management area setting unit 107 does not set the management area 83. This suppresses a decrease in productivity at the work site.

In addition, before the setting of the management area 83 is started, when the setting of the management area 83 is started in a state where the another unmanned vehicle 2A or the auxiliary vehicle 3 is approaching the scheduled area 83P, there is a possibility that the unmanned vehicle 2 moving in the management area 83 hinders traveling of the another unmanned vehicle 2A or the auxiliary vehicle 3. As a result, productivity at the work site may be reduced.

The position of the another unmanned vehicle 2A is detected by the position sensor 71 of the another unmanned vehicle 2A. The position of the auxiliary vehicle 3 is detected by the position sensor 41. The surrounding situation determination unit 108 can determine whether the another unmanned vehicle 2A or the auxiliary vehicle 3 is approaching the scheduled area 83P based on the detection data of the position sensor 71 of the another unmanned vehicle 2A and the detection data of the position sensor 41 of the auxiliary vehicle 3. When the another unmanned vehicle 2A and the auxiliary vehicle 3 are not approaching the scheduled area 83P, the surrounding situation determination unit 108 determines that the setting of the management area 83 is allowed to be started. When the another unmanned vehicle 2A or the auxiliary vehicle 3 is approaching the scheduled area 83P, the surrounding situation determination unit 108 determines that the setting of the management area 83 is not allowed to be started. When the surrounding situation determination unit 108 determines that the setting of the management area 83 is allowed to be started, the management area setting unit 107 sets the management area 83. When the surrounding situation determination unit 108 determines that the setting of the management area 83 is not allowed to be started, the management area setting unit 107 does not set the management area 83. This suppresses a decrease in productivity at the work site.

When the start determination unit 106 determines that the unmanned vehicle 2 does not start in spite of the start command Ca, the notification unit 109 notifies the target outside the unmanned vehicle 2 that the setting of the management area 83 is to be started.

An example of the target outside the unmanned vehicle 2 includes the course data generation unit 211 of the management device 21. In addition, examples of the target outside the unmanned vehicle 2 include the another unmanned vehicle 2A and the auxiliary vehicle 3.

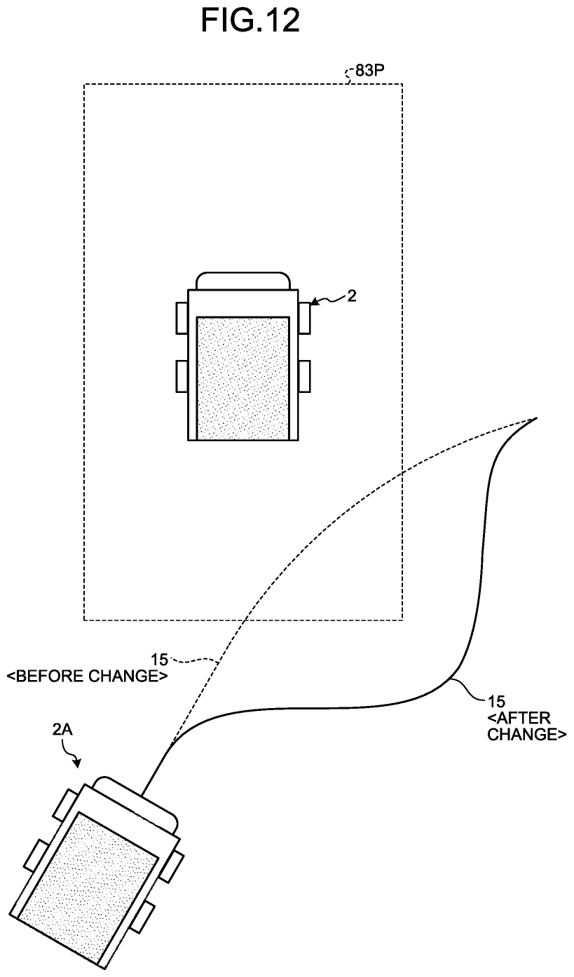

FIG. 12 is a diagram for explaining that the course data of the another unmanned vehicle 2A is changed according to the notification from the notification unit 109 according to the embodiment.

When it is determined that the unmanned vehicle 2 does not start in spite of the start command Ca, the notification unit 109 notifies the course data generation unit 211 that the setting of the management area 83 is to be started before the setting of the management area 83 is started. In addition, the notification unit 109 notifies the course data generation unit 211 of the scheduled area 83P.

The course data generation unit 211 generates course data of the another unmanned vehicle 2A based on the scheduled area 83P notified from the notification unit 109. In the embodiment, the course data generation unit 211 determines whether the travel course 15 of the another unmanned vehicle 2A is provided in the scheduled area 83P based on the position of the scheduled area 83P notified from the notification unit 109. When it is determined that the travel course 15 of the another unmanned vehicle 2A is provided in the scheduled area 83P, the course data generation unit 211 generates course data of the another unmanned vehicle 2A so that the travel course 15 of the another unmanned vehicle 2A is away from the scheduled area 83P. The travel course 15 of the another unmanned vehicle 2A is changed so as to avoid the scheduled area 83P. In addition, the travel course 15 of the another unmanned vehicle 2A is changed so that the another unmanned vehicle 2A traveling along the travel course 15 does not overlap the scheduled area 83P. The course data generation unit 211 transmits the changed course data to the another unmanned vehicle 2A. The another unmanned vehicle 2A travels along the changed travel course 15. Since the changed travel course 15 is away from the scheduled area 83P, the another unmanned vehicle 2A can travel so as to avoid the management area 83. The management area setting unit 107 can set the management area 83 after changing the travel course 15 of the another unmanned vehicle 2A to be away from the scheduled area 83P. Since traveling of the another unmanned vehicle 2A is prevented from being hindered by the unmanned vehicle 2, a decrease in productivity of the work site is suppressed.

When the start determination unit 106 determines that the unmanned vehicle 2 does not start in spite of the start command Ca, the notification unit 109 may notify the auxiliary vehicle 3 of the start of the setting of the management area 83 and the scheduled area 83P before the setting of the management area 83 is started. The control device 40 of the auxiliary vehicle 3 causes the output device 42 of the auxiliary vehicle 3 to output the position of the scheduled area 83P notified from the notification unit 109. The driver of the auxiliary vehicle 3 can check the position of the scheduled area 83P output to the output device 42 and travel in the travel area 4 so as to avoid the scheduled area 83P. Since traveling of the auxiliary vehicle 3 is prevented from being hindered by the unmanned vehicle 2, a decrease in productivity of the work site is suppressed.

In addition, the notification unit 109 notifies the target outside the unmanned vehicle 2 that the setting of the management area 83 is completed.

An example of the target outside the unmanned vehicle 2 includes the course data generation unit 211 of the management device 21. In addition, examples of the target outside the unmanned vehicle 2 include the another unmanned vehicle 2A and the auxiliary vehicle 3.

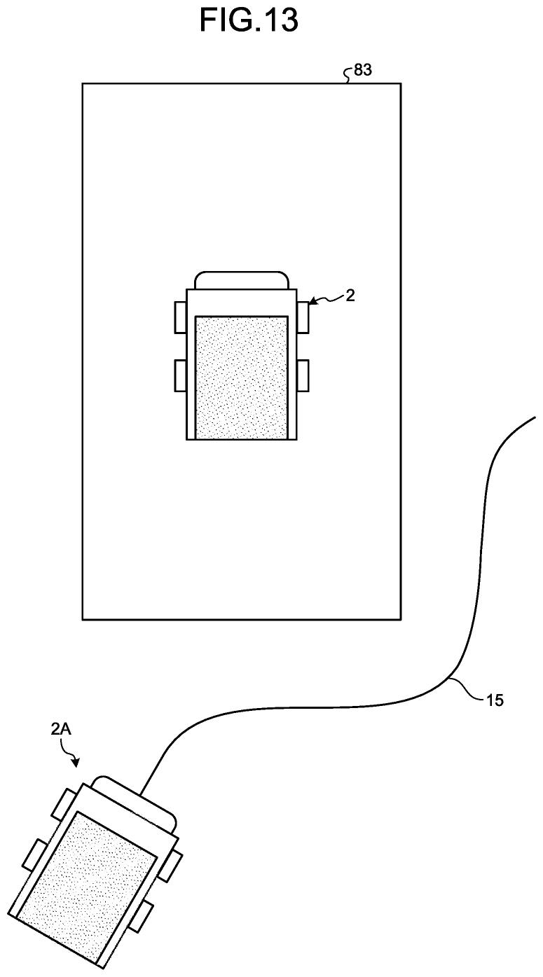

FIG. 13 is a diagram for explaining that course data of the another unmanned vehicle 2A is generated according to the notification from the notification unit 109 according to the embodiment.

In a case where the management area 83 is set in the start control, the notification unit 109 notifies the course data generation unit 211 that the setting of the management area 83 has ended after the setting of the management area 83 is completed. In addition, the notification unit 109 notifies the course data generation unit 211 of the management area 83 set by the management area setting unit 107.

The course data generation unit 211 generates course data of the another unmanned vehicle 2A based on the management area 83 notified from the notification unit 109. In the embodiment, the course data generation unit 211 generates the course data of the another unmanned vehicle 2A so that the travel course 15 of the another unmanned vehicle 2A is away from the management area 83 based on the position of the management area 83 notified from the notification unit 109. The travel course 15 of the another unmanned vehicle 2A is created so as to avoid the management area 83. The course data generation unit 211 transmits the generated course data to the another unmanned vehicle 2A. The another unmanned vehicle 2A travels along the travel course 15. Since the travel course 15 of the another unmanned vehicle 2A is away from the management area 83, the another unmanned vehicle 2A can travel so as to avoid the management area 83. As a result, it is suppressed that the unmanned vehicle 2 moving in the management area 83 hinders traveling of the another unmanned vehicle 2A. Therefore, a decrease in productivity at the work site is suppressed.

After the setting of the management area 83 is completed, the notification unit 109 may notify the auxiliary vehicle 3 of the completion of the setting of the management area 83 and the management area 83. The control device 40 of the auxiliary vehicle 3 causes the output device 42 of the auxiliary vehicle 3 to output the position of the management area 83 notified from the notification unit 109. The driver of the auxiliary vehicle 3 can check the position of the management area 83 output to the output device 42 and travel in the travel area 4 so as to avoid the management area 83. As a result, it is suppressed that the unmanned vehicle 2 moving in the management area 83 hinders traveling of the auxiliary vehicle 3. Therefore, a decrease in productivity at the work site is suppressed.

[Control Method]

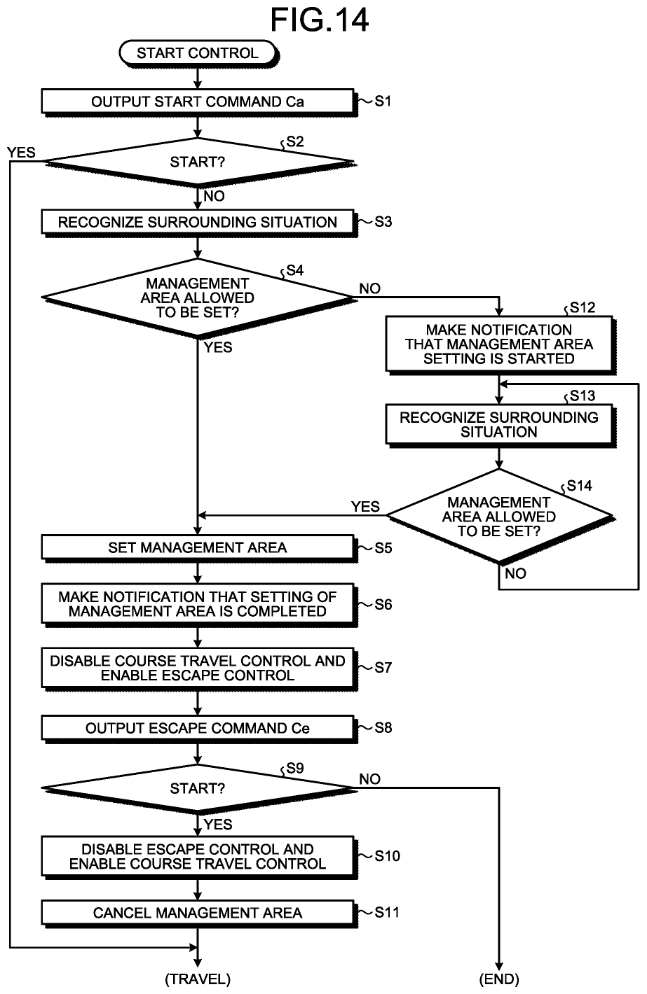

FIG. 14 is a flowchart illustrating a control method of the unmanned vehicle 2 according to the embodiment. In the following description, the start control when the unmanned vehicle 2 in the stopped state starts to move forward at the work site 1 will be described.

The travel control unit 104 outputs the start command Ca to the drive device 55 in order to start the start of the unmanned vehicle 2 (step S1).

The start determination unit 106 determines whether the unmanned vehicle 2 has started based on the traveling speed of the unmanned vehicle 2, the acceleration of the unmanned vehicle 2, and the movement distance of the unmanned vehicle 2. For example, it is determined, based on the specified time T and the detection data of the speed sensor 74, whether the unmanned vehicle 2 has started in response to the start command Ca (step S2).

In step S2, when it is determined that the unmanned vehicle 2 has started in response to the start command Ca (step S2: Yes), the travel control unit 104 starts the course travel control. The unmanned vehicle 2 travels in the work site 1 according to the course data.

In step S2, when it is determined that the unmanned vehicle 2 does not start in spite of the start command Ca (step S2: No), the surrounding situation determination unit 108 recognizes the surrounding situation of the unmanned vehicle 2 before the setting of the management area 83 is started (step S3).

The surrounding situation determination unit 108 determines whether the management area 83 is allowed to be set based on the recognized surrounding situation (step S4).

When the travel course 15 of the another unmanned vehicle 2A is not provided in the scheduled area 83P, the surrounding situation determination unit 108 determines that the management area 83 is allowed to be set. When the travel course 15 of the another unmanned vehicle 2A is provided in the scheduled area 83P, the surrounding situation determination unit 108 determines that the management area 83 is not allowed to be set.

Note that the surrounding situation determination unit 108 may determine that the management area 83 is not allowed to be set when the another unmanned vehicle 2A or the auxiliary vehicle 3 approaches or exists in the scheduled area 83P, and may determine that the setting of the management area 83 is allowed to be started when the another unmanned vehicle 2A or the auxiliary vehicle 3 is away from the scheduled area 83P. The surrounding situation determination unit 108 can determine whether the another unmanned vehicle 2A approaches or exists in the scheduled area 83P based on the detection data of the position sensor 71 of the another unmanned vehicle 2A. The surrounding situation determination unit 108 can determine whether the auxiliary vehicle 3 approaches or exists in the scheduled area 83P based on the detection data of the position sensor 41 of the auxiliary vehicle 3.

When it is determined in step S4 that the management area 83 is allowed to be set (step S4: Yes), the management area setting unit 107 sets the management area 83 (step S5).

The notification unit 109 notifies the target outside the unmanned vehicle 2 that the setting of the management area 83 is completed after the setting of the management area 83. In the embodiment, the notification unit 109 notifies the course data generation unit 211 that the setting of the management area 83 is completed (step S6).

As a result, the course data generation unit 211 can generate the course data of the another unmanned vehicle 2A so that the another unmanned vehicle 2A avoids the management area 83.

After setting the management area 83, the course data setting unit 102 disables the course travel control and enables the escape control (step S7).

After the course travel control is disabled and the escape control is enabled, the travel control unit 104 outputs the escape command Ce (step S8).

The traveling device 51 performs the escape operation based on the escape command Ce. The traveling device 51 performs the escape operation based on the escape condition stored in the escape condition storage unit 111.

The start determination unit 106 determines whether the unmanned vehicle 2 has started in response to the escape command Ce based on, for example, the specified time T and the detection data of the speed sensor 74 (step S9).

In step S9, when it is determined that the unmanned vehicle 2 has started in response to the escape command Ce (step S9: Yes), the course data setting unit 102 disables the escape control and enables the course travel control (step S10).

The travel control unit 104 starts course travel control. The unmanned vehicle 2 travels in the work site 1 according to the course data.

Note that the course data used for the course travel control may be existing course data or may be course data newly generated based on the position of the unmanned vehicle 2 after the unmanned vehicle 2 starts by the escape operation. For example, when the management device 21 detects that the deviation between the actual position or the actual azimuth of the unmanned vehicle 2 by the escape operation and the target position or the target azimuth defined by the existing course data is likely to increase, the position of the unmanned vehicle 2 may be predicted based on the traveling speed and the attitude of the unmanned vehicle 2 after the unmanned vehicle 2 starts by the escape operation, and new course data may be generated. The unmanned vehicle 2 travels based on the course data newly generated after the course travel control is started, thereby reducing unnecessary travel of the unmanned vehicle 2 for reducing the deviation between the actual position or actual azimuth and the target position or target azimuth. This suppresses a decrease in productivity at the work site.

After the course travel control is started and the deviation between the actual position of the unmanned vehicle 2 and the travel course 15 is the allowable value or less, the management area setting unit 107 cancels the management area 83 (step S11).

In step S4, when it is determined that the management area 83 is not allowed to be set (step S4: No), the notification unit 109 notifies the target outside the unmanned vehicle 2 that the setting of the management area 83 is started. In the embodiment, the notification unit 109 notifies the course data generation unit 211 that the setting of the management area 83 is started. In the embodiment, the notification unit 109 notifies the auxiliary vehicle 3 that the setting of the management area 83 is started (step S12).

When the start of the setting of the management area 83 is notified to the course data generation unit 211, the course data generation unit 211 can generate the course data of the another unmanned vehicle 2A so that the another unmanned vehicle 2A avoids the scheduled area 83P.

When the start of the setting of the management area 83 is notified to the auxiliary vehicle 3, the auxiliary vehicle 3 can travel so as to avoid the scheduled area 83P.

After the start of the setting of the management area 83 is notified, the surrounding situation determination unit 108 recognizes the surrounding situation of the unmanned vehicle 2 (step S13).

The surrounding situation determination unit 108 determines whether the management area 83 is allowed to be set based on the recognized surrounding situation (step S14).

For example, according to the notification of the start of the setting of the management area 83 and the scheduled area 83P, in a case where the travel course 15 of the another unmanned vehicle 2A is generated so as to avoid the scheduled area 83P, in a case where the another unmanned vehicle 2A travels so as to be away from the scheduled area 83P, or in a case where the auxiliary vehicle 3 travels so as to avoid the scheduled area 83P, the surrounding situation determination unit 108 determines that the management area 83 is allowed to be set.

In step S14, when it is determined that the management area 83 is allowed to be set (step S14: Yes), the process from step S5 to step S11 is performed.

In step S14, when it is determined that the management area 83 is not allowed to be set (step S14: No), the process of step S13 is performed. The process of step S13 and the process of step S14 are performed until it is determined that the management area 83 is allowed to be set.

In step S9, when it is determined that the unmanned vehicle 2 does not start in spite of the escape command Ce (step S9: No), the escape control ends. For example, an error signal is output to the management device 21, and an escape process by a driver's driving operation is performed on the unmanned vehicle 2.

[Effects]

As described above, according to the embodiment, when it is determined that the unmanned vehicle 2 does not start in spite of the start command Ca, the management area setting unit 107 sets the management area 83 where the unmanned vehicle 2 is allowed to move. The travel control unit 104 outputs the escape command Ce for causing the traveling device 51 to perform an escape operation in a state where the unmanned vehicle 2 is restricted from moving to the outside of the management area 83. When the traveling device 51 performs the escape operation different from the start operation, the unmanned vehicle 2 that was not able to start in spite of the start command Ca can start in response to the escape command Ce. Since the unmanned vehicle 2 can be started, a decrease in productivity at the work site is suppressed.

The travel control unit 104 outputs the escape command Ce in a state where the course travel control is disabled. Since the course travel control is disabled, the travel control unit 104 can freely move the unmanned vehicle 2 inside the management area 83 and can freely perform the escape operation of the traveling device 51. As a result, the tire 54 can escape from the buried state.

The management area setting unit 107 sets the management area 83 with reference to the position of the unmanned vehicle 2 at the time point when the start determination unit 106 determines that the unmanned vehicle 2 does not start in spite of the start command Ca. That is, the edge of the management area 83 is disposed around the unmanned vehicle 2 at the time point when the start determination unit 106 determines that the unmanned vehicle 2 does not start. As a result, the management area 83 is appropriately set. The unmanned vehicle 2 can freely move forward, backward, leftward, and rightward inside the management area 83.

When the unmanned vehicle 2 was not able to start in spite of the start command Ca for moving the unmanned vehicle 2 forward, the travel control unit 104 outputs the escape command Ce for moving the unmanned vehicle 2 backward. When the unmanned vehicle 2 was not able to move forward in spite of the start command Ca, the unmanned vehicle 2 moves backward based on the escape command Ce, whereby the tire 54 can escape from the buried state.

In addition, when the unmanned vehicle 2 was not able to start in spite of the start command Ca for moving the unmanned vehicle 2 forward, the travel control unit 104 outputs the escape command Ce for causing the unmanned vehicle 2 to repeat forward movement and backward movement. When the unmanned vehicle 2 was not able to move forward in spite of the start command Ca, the unmanned vehicle 2 repeats forward movement and backward movement based on the escape command Ce, whereby the tire 54 can escape from the buried state.

When the unmanned vehicle 2 was not able to start in spite of the start command Ca for moving the unmanned vehicle 2 forward, the travel control unit 104 outputs the escape command Ce for changing the steering angle of the front wheel 53F in a state where the driving force De for starting the unmanned vehicle 2 is generated. When the unmanned vehicle 2 was not able to move forward in spite of the start command Ca, the front wheel 53F is steered in the steering range based on the escape command Ce, whereby the tire 54 can escape from the buried state.

The escape condition storage unit 111 stores an escape condition that defines an escape operation. The travel control unit 104 outputs the escape command Ce based on the escape condition stored in the escape condition storage unit 111. When the escape condition is defined based on an empirical rule that allows the tire 54 to escape from the buried state, the traveling device 51 can appropriately perform the escape operation.

The management area setting unit 107 sets the management area 83 based on the surrounding situation of the unmanned vehicle 2 before the setting of the management area 83 is started. On the basis of the surrounding situation of the unmanned vehicle 2, propriety of setting of the management area 83 is determined. When it is determined that the setting of the management area 83 is inappropriate, the management area 83 is not set. When it is determined that the setting of the management area 83 is appropriate, the management area 83 is set. This suppresses a decrease in productivity at the work site.

The notification unit 109 notifies a target outside the unmanned vehicle 2 that the setting of the management area 83 is started before the start of the setting of the management area 83. This prevents the unmanned vehicle 2 that performs the escape operation from hindering traveling of the another unmanned vehicle 2A or the auxiliary vehicle 3. Therefore, a decrease in productivity at the work site is suppressed.

The notification unit 109 notifies a target outside the unmanned vehicle 2 that the setting of the management area 83 is completed. As a result, it is suppressed that the unmanned vehicle 2 that performs the escape operation hinders traveling of the another unmanned vehicle 2A or the auxiliary vehicle 3. Therefore, a decrease in productivity at the work site is suppressed.

### OTHER EMBODIMENTS

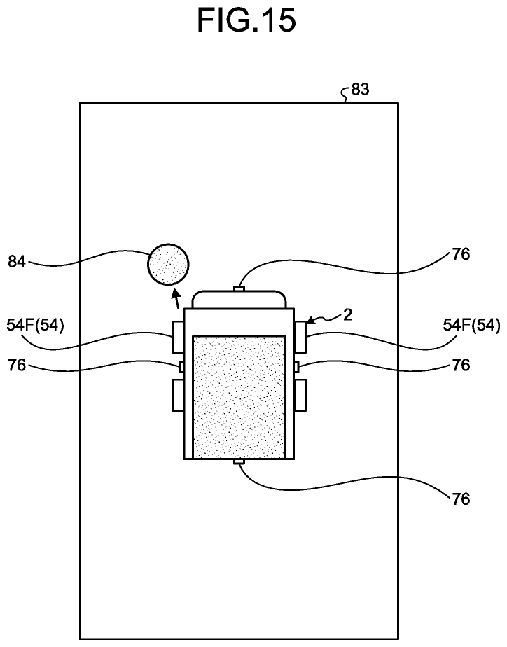

FIG. 15 is a diagram for explaining start control according to the embodiment. In the above-described embodiment, when the tire 54 is caused to escape from the buried state, the traveling device 51 performs the escape operation based on the escape condition stored in the escape condition storage unit 111. The traveling device 51 may perform the escape operation based on the detection data of a peripheral sensor 76.

As illustrated in FIG. 15, the peripheral sensor 76 is provided in the unmanned vehicle 2. The peripheral sensor 76 can detect a road surface condition around the unmanned vehicle 2. An example of the peripheral sensor 76 includes an imaging device. Detection data of the road surface condition around the unmanned vehicle 2 detected by the peripheral sensor 76 is transmitted to the control device 30. The sensor data acquisition unit 103 acquires detection data of a road surface condition around the unmanned vehicle 2. The travel control unit 104 outputs the escape command Ce based on the detection data of the road surface condition.

The peripheral sensor 76 detects, for example, an escape attainable site 84 of the road surface 81. Examples of the escape attainable site 84 include a hard site of the road surface 81 and a site where many rocks are present. In addition, an example of the escape attainable site 84 includes a site in the vicinity of the tire 54 having a shallowly buried depth among the four tires 54. The travel control unit 104 controls the steering device 58 so that the tire 54 rides on the escape attainable site 84 based on the detection data of the peripheral sensor 76. As a result, the tire 54 of the unmanned vehicle 2 can escape from the buried state.

In the above-described embodiment, the drive wheel is the rear wheel 53R, and the steering wheel is the front wheel 53F. The drive wheel may be the front wheel 53F or may be both the front wheel 53F and the rear wheel 53R. The steering wheel may be the rear wheel 53R or may be both the front wheel 53F and the rear wheel 53R.

In the above-described embodiment, when the start determination unit 106 determines that the unmanned vehicle 2 does not start in spite of the start command Ca, the management area setting unit 107 sets the management area 83. The management area setting unit 107 may set the management area 83 based on a control command transmitted from the management device 21. For example, when the administrator of the control facility 13 determines that the unmanned vehicle 2 does not start in spite of the start command Ca, the management area setting unit 107 can set the management area 83 based on the control command transmitted from the management device 21. In addition, the management area setting unit 107 may set the management area 83 based on an operation command transmitted from the auxiliary vehicle 3. For example, when the driver of the auxiliary vehicle 3 determines that the unmanned vehicle 2 does not start in spite of the start command Ca, the management area setting unit 107 can set the management area 83 based on the control command transmitted from the control device 40 of the auxiliary vehicle 3.

In the above-described embodiment, the management area setting unit 107 may set a three-dimensional management space in which the unmanned vehicle 2 is allowed to move instead of the management area 83. The height of the management space may be determined as a distance between the ground with which the tires 54 are in contact and the highest part of the unmanned vehicle 2. An example of the highest part of the unmanned vehicle 2 includes a GNSS antenna connected to a GNSS receiver. When the position of the highest part of the unmanned vehicle 2 changes, the height of the management space may be changed in accordance with the change in the position of the highest part of the unmanned vehicle 2. For example, when the highest part of the unmanned vehicle 2 is defined in the dump body 52 and the dump body 52 performs the dumping operation, the position of the highest part of the unmanned vehicle 2 changes. The management area setting unit 107 may change the height of the management space in accordance with the dumping operation of the dump body 52.

In the above-described embodiment, the start condition is generated by the start condition generation unit 105. The start condition may be generated by an arithmetic processing device different from the control device 30. The start condition generated by the arithmetic processing device may be stored in the start condition storage unit 110. The travel control unit 104 can perform start control of the unmanned vehicle 2 using the start condition stored in the start condition storage unit 110.

In the above-described embodiment, at least some of the functions of the control device 30 may be provided in the management device 21, or at least some of the functions of the management device 21 may be provided in the control device 30. For example, in the above-described embodiment, the management device 21 may have the function of the start condition generation unit 105. The start condition may be transmitted from the management device 21 to the control device 30 of the unmanned vehicle 2 via the communication system 24. The travel control unit 104 can perform start control of the unmanned vehicle 2 using the start condition transmitted from the management device 21. Furthermore, the management device 21 may have the functions of, for example, the start determination unit 106 and the surrounding situation determination unit 108.

In the above-described embodiment, each of the course data acquisition unit 101, the course data setting unit 102, the sensor data acquisition unit 103, the travel control unit 104, the start condition generation unit 105, the start determination unit 106, the management area setting unit 107, the surrounding situation determination unit 108, the notification unit 109, the start condition storage unit 110, and the escape condition storage unit 111 may be configured by discrete hardware.

In the above-described embodiment, the unmanned vehicle 2 may be a mechanically driven dump truck or an electrically driven dump truck.

### REFERENCE SIGNS LIST

1 WORK SITE
2 UNMANNED VEHICLE
2A ANOTHER UNMANNED VEHICLE
3 AUXILIARY VEHICLE
4 TRAVEL AREA
5 LOADING AREA
6 DISCHARGING AREA
7 PARKING AREA
8 FUEL FILLING AREA
9 TRAVELING PATH
10 INTERSECTION
11 LOADER
12 CRUSHER
13 CONTROL FACILITY
14 COURSE POINT
15 TRAVEL COURSE
20 MANAGEMENT SYSTEM
21 MANAGEMENT DEVICE
21A PROCESSOR
21B MAIN MEMORY
21C STORAGE
21D INTERFACE
21E COMPUTER PROGRAM
22 INPUT DEVICE
24 COMMUNICATION SYSTEM
24A WIRELESS COMMUNICATION DEVICE
24B WIRELESS COMMUNICATION DEVICE
24C WIRELESS COMMUNICATION DEVICE
30 CONTROL DEVICE
30A PROCESSOR
30B MAIN MEMORY
30C STORAGE
30D INTERFACE
30E COMPUTER PROGRAM
40 CONTROL DEVICE
40A PROCESSOR
40B MAIN MEMORY
40C STORAGE
40D INTERFACE
40E COMPUTER PROGRAM
41 POSITION SENSOR
42 OUTPUT DEVICE
50 VEHICLE BODY
51 TRAVELING DEVICE
52 DUMP BODY
53 WHEEL
53F FRONT WHEEL
53R REAR WHEEL
54 TIRE
54B LOWER END PORTION
54F FRONT TIRE
54R REAR TIRE
55 DRIVE DEVICE
56 BRAKE DEVICE
57 TRANSMISSION DEVICE
58 STEERING DEVICE
59 POWER TRANSMISSION MECHANISM
60 HYDRAULIC DEVICE
61 STEERING CYLINDER
62 HOIST CYLINDER
63 HYDRAULIC PUMP
64 VALVE DEVICE
71 POSITION SENSOR
72 AZIMUTH SENSOR
73 INCLINATION SENSOR
74 SPEED SENSOR
75 STEERING SENSOR
76 PERIPHERAL SENSOR
81 ROAD SURFACE
82 LOAD
83 MANAGEMENT AREA
83P SCHEDULED AREA
84 ESCAPE ATTAINABLE SITE
100 CONTROL SYSTEM
101 COURSE DATA ACQUISITION UNIT
102 COURSE DATA SETTING UNIT
103 SENSOR DATA ACQUISITION UNIT
104 TRAVEL CONTROL UNIT
105 START CONDITION GENERATION UNIT
106 START DETERMINATION UNIT
107 MANAGEMENT AREA SETTING UNIT
108 SURROUNDING SITUATION DETERMINATION UNIT
109 NOTIFICATION UNIT
110 START CONDITION STORAGE UNIT
111 ESCAPE CONDITION STORAGE UNIT
211 COURSE DATA GENERATION UNIT
Ca START COMMAND
Ce ESCAPE COMMAND
Da DRIVING FORCE
De DRIVING FORCE
PA PITCH AXIS
Pθ PITCH ANGLE
RA ROLL AXIS
Rθ ROLL ANGLE
ta TIME POINT
tb TIME POINT
T SPECIFIED TIME
Va COMMAND VALUE
Vb COMMAND VALUE
YA YAW AXIS
Yθ YAW ANGLE

1. An unmanned vehicle control system comprising:
a travel control unit that outputs a start command for starting an unmanned vehicle; and
a management area setting unit that sets a management area in which the unmanned vehicle is allowed to move in a case where it is determined that the unmanned vehicle does not start in spite of the start command, wherein
the travel control unit outputs an escape command for causing a traveling device of the unmanned vehicle to perform an escape operation in a state where movement of the unmanned vehicle to an outside of the management area is restricted.

2. The unmanned vehicle control system according to claim 1, further comprising:
a course data acquisition unit that acquires course data indicating a traveling condition of the unmanned vehicle; and
a course data setting unit that switches between enabling and disabling of course travel control performed based on the course data, wherein
the travel control unit outputs the escape command in a state where the course travel control is disabled.

3. The unmanned vehicle control system according to claim 1, wherein
the management area setting unit sets the management area such that an edge of the management area is disposed around the unmanned vehicle at a time point when it is determined that the unmanned vehicle does not start.

4. The unmanned vehicle control system according to claim 1, wherein
the start command includes causing the unmanned vehicle to start in a predetermined movement direction, and
the escape operation includes traveling in a direction opposite to the movement direction.

5. The unmanned vehicle control system according to claim 1, wherein
the escape operation includes repeating forward movement and backward movement.

6. The unmanned vehicle control system according to claim 1, wherein
the escape operation includes changing a steering angle of a steering wheel of the unmanned vehicle in a state where a driving force for starting the unmanned vehicle is generated.

7. The unmanned vehicle control system according to claim 1, further comprising:
an escape condition storage unit that stores an escape condition defining the escape operation, wherein
the travel control unit outputs the escape command based on the escape condition.

8. The unmanned vehicle control system according to claim 1, further comprising:
a sensor data acquisition unit that acquires detection data of a road surface condition around the unmanned vehicle, wherein
the travel control unit outputs the escape command based on the detection data of the road surface condition.

9. The unmanned vehicle control system according to claim 1, further comprising:
a surrounding situation determination unit that determines whether setting of the management area is allowed to be started based on a surrounding situation of the unmanned vehicle before the setting of the management area is started, wherein
the management area setting unit sets the management area based on a result of determination by the surrounding situation determination unit.

10. The unmanned vehicle control system according to claim 9, wherein
the surrounding situation includes at least one of course data of a moving object around the unmanned vehicle with respect to the management area and a position of the moving object around the unmanned vehicle with respect to the management area.

11. The unmanned vehicle control system according to claim 1, further comprising:
a notification unit that notifies a target outside the unmanned vehicle that setting of the management area is to be started before the setting of the management area is started.

12. The unmanned vehicle control system according to claim 11, wherein
the target includes a course data generation unit that generates course data of a moving object,
the notification unit makes a notification of a scheduled area for which setting of the management area is scheduled, and
the course data generation unit generates the course data based on the scheduled area.

13. The unmanned vehicle control system according to claim 1, further comprising:
a notification unit that notifies a target outside the unmanned vehicle that setting of the management area is completed.

14. The unmanned vehicle control system according to claim 13, wherein
the target includes a course data generation unit that generates course data of a moving object,
the notification unit makes a notification of the management area, and
the course data generation unit generates the course data based on the management area.

15. An unmanned vehicle comprising:
the unmanned vehicle control system according to claim 1.

16. An unmanned vehicle control method comprising:
outputting a start command for starting an unmanned vehicle;
setting a management area in which the unmanned vehicle is allowed to move in a case where it is determined that the unmanned vehicle does not start in spite of the start command; and
outputting an escape command for causing a traveling device of the unmanned vehicle to perform an escape operation in a state where movement of the unmanned vehicle to an outside of the management area is restricted.
